(19) United States
(12) Patent Application Publication
(10) Pub. No.: US 2021/0265787 A1
(43) Pub. Date: Aug. 26, 2021

(54) TAMPER RESISTANT POWER RECEPTACLE

(71) Applicant: Vernon R. Sandel, Licking, MO (US)

(72) Inventor: Vernon R. Sandel, Licking, MO (US)

(21) Appl. No.: 17/317,612

(22) Filed: May 11, 2021

Related U.S. Application Data
(63) Continuation of application No. 15/063,453, filed on Mar. 7, 2016, now Pat. No. 11,011,877.
(60) Provisional application No. 62/128,868, filed on Mar. 5, 2015.

(51) Int. Cl. H01R 13/71; H01R 13/44

(52) U.S. Cl. CPC H01R 13/71; H01R 24/78; H01R 13/44

(57) ABSTRACT

The present invention provides a power outlet with safety features having the form and size to fit standard electrical boxes. The present invention includes of one or more switched sockets which are generally switched on by movement from a first position to a second position. The described movement is prevented by one or more locks configured to be unlocked by complete insertion of a plug's power blades into the socket. In addition, optional blade locks may be provided to prevent removal of the plug once the movement from the first position to the second position has begun. The movements described herein are fixed, linear and rotary. An embodiment adapted for use with an extension cord socket is also presented.

### CROSS-REFERENCE TO RELATED APPLICATIONS

This claims the benefit of the prior filed U.S. provisional application No. 62/128,868 filed on Mar. 5, 2015 which is incorporated herein by reference.

### FIELD OF THE INVENTION

The present invention is broadly directed to power outlets and, more particularly, to an improved safety power outlet which has a child-proof, tamper resistant features.

### BACKGROUND OF THE INVENTION

An inexpensive, convenient and easy to manufacture safety electrical power receptacle has long been sought to protect children. These have taken the form of devices which block the access slots for the plug blades or switched outlets wherein the contacts in the electrically active slots are not connected to power until a plug is inserted. Since 2008 the National Electrical Code has required tamper resistant (child resistant) power receptacles in all new residential construction and renovation. One commonly available commercial products that meet these code requirements uses tamper resistant receptacles with shutters over the two power blade slots which open when the two ramped shutters are pressed aside simultaneously as with the two power blades of a plug. While this is an improvement over the prior art, these are easily defeated and present other disadvantages. For example, the shuttered slot design requires care in inserting of the plug into the socket because the two plug blades have to touch the two shutters at exactly the same time, otherwise the plug may be rejected. This can be more challenging when a receptacle is not at eye level or when a receptacle is behind furniture or in other encumbered, hard to reach locations. Additionally, even these shuttered receptacles safety features can be defeated by using two objects to open the shutters or by a paper clip bent in the shape of a “U”. Obviously, therefore, safety receptacles which receive a plug as easily as the prior non-tamper resistant standard receptacles and which have safety features which are harder to defeat are desirable.

The prior art contains a number of switched receptacles, the switches being operated either by the plug tines themselves, or more commonly by either a rotation or linear motion. Those operated by the plug tines involve a plurality of contacts which are closed by the insertion of the male plug tines. This type of switch is prone to arcing if the device being powered is already switched on, and eventually leads to fusion of the contacts and loss of the safety features. The movement switched receptacles can use a more robust type of switch.

U.S. Pat. No. 3,775,726 is an example of a safety receptacle of non-standard form or size but which includes a number of safety elements including: spring biased blocks that prevent a lateral motion until the power prongs of a plug push them out of the path of two “L” shaped prongs designed to penetrate the holes in the blades of standard plugs to retain the plug, and a switch that is turned on at the end of the lateral travel. This solution is similar to the shuttered receptacles, being easily defeated by inserting two thin foreign objects or a “U” shaped wire such as one bent from a paperclip. It would not interfere with the locking tines if inserted at either end of the plug blade slots, and thus would not block the lateral motion to power the socket.

U.S. Pat. No. 4,832,886 describes a sliding socket in which movement toward the rear wall urges a bendable articulated arm carrying a pin through the power tine holes to retain a plug while switching power to tine contacts within the socket. The depressed condition is retained by a push to slide-push to release mechanism similar to a ball point pen. If the socket face is pushed without a plug, the arm blocks access to the powered tine contacts in the socket. It appears that the safety features can be easily defeated by inserting a thin object such as a needle or wire which would not block the plug blade holes into the socket and depressing the socket with a finger. This design also has non-standard size and form.

U.S. Pat. No. 5,286,213 describes a receptacle and an extension cord outlet which secure an inserted plug and powers it by twisting the plug and socket relative to the receptacle body. During the twisting movement, an internal ramp presses nubs against blade receiving contacts putting pressure on the broad sides of the power blades to fix the blades in the socket as an electrical connection to the power supply takes place. The nubs may hold small bumps or pins that engage the holes in the plug power blades to increase the holding power. There is no lock to prevent unwanted movement to the powered state.

U.S. Pat. No. 5,795,168 describes a receptacle of standard size and form in which a plug is inserted, pushed inward against a spring bias, rotated to a stop and is powered when the spring is allowed to push the socket outward to powering contacts. During the rotation a central actuator urges spring mounted pins into plug blade holes to retain the plug, but if rotation occurs without a plug in the socket the actuator also urges a shutter over the socket's plug blade contact. Since both the shutters and pins are on resilient membranes, it appears that sticking a foreign object into the socket before rotating, pushing it inward, rotating the socket and releasing would power the foreign object. A finger nail file or a paper clip would defeat the safety features. Also, if the socket were rotated to the powered position a needle, knife blade, or other pointed object could push the shutter aside, thus reaching the powered hot terminal.

U.S. Pat. No. 8,926,350 uses the same sequence of steps as U.S. Pat. No. 5,795,168 to power a plug inserted into a socket. In the twisting operation a ramp urges a pin through holes in the socket's plug receiving contacts to lock the plug in the socket. This design suffers from the same safety deficiency as the similar design except for the fact that the twist may be stopped if the foreign object does not allow the pin to complete its travel through the holes in the socket's plug receiving contacts. A plug is not needed to push the socket inward as a finger would work equally well. There is no significant resistance to the twisting action as it is only the compression of the return springs of the locking pins in the ramp. Therefore, pressing the socket with the fingers and using the finger nails or a foreign object to rotate the socket would result in an unsafe powered socket.

It would therefore be beneficial to have a rotary or linear switched safety receptacle which moves from an unpowered condition or state to a power condition or state upon receive of a plug and returns tot eh unpowered position upon removal of the plug while preventing the foreign objects from tampering with the safety receptacle, thereby enhancing safety. The safety receptacle also being designed for receipt of a plug in a similar manner as a known or existing receptacles. This invention addresses some of these objectives.

### SUMMARY OF THE INVENTION

The current invention presents switched outlets that power an inserted plug when the socket is moved from a first position to a second position. This movement could be either a linear or a rotational motion, however the examples will use a linear movement toward the rear of the receptacle identical to the usual action in inserting a plug. The movement locks the plug power blades of an inserted plug into the socket and terminates with the turning on of a switch, thus powering the plug. The blade lock retains the plug in the socket until the switch is turned off, so that it cannot be removed when in the powered condition. Locks in the power blade slots of the sockets may be used to prevent movement of the socket from the first position to the second position unless the two electrically active blades of a plug are fully inserted.

It is the object of this invention to provide the following: 1) Tamper resistant receptacles that are very hard to defeat. 2) Tamper resistant receptacles that accept a plug as easily as the former non-safety standard receptacles. 3) Tamper resistant receptacles which fit the standard electrical boxes and have shape and form factors that are essentially the same as the formerly used non-tamper resistant power receptacles. 4) Tamper resistant receptacles that eliminate possible dangers from plugs only partially inserted or pulled out, having partially exposed blades. 5) Tamper resistant receptacles that can be easily and inexpensively manufactured. 6) Tamper resistant receptacles which work with all standard plugs, whether they are of the two or three prong variety, polarized or not, or whether they have holes in the blades or not.

Various objects and advantages of the present invention will become apparent from the following description taken in conjunction with the accompanying drawings wherein are set forth, by way of illustration and example, certain embodiments of this invention. The drawings submitted herewith constitute a part of this specification, include exemplary embodiments of the present invention, and illustrate various objects and features thereof.

### BRIEF DESCRIPTION OF THE DRAWINGS

FIG. 1 is a side perspective view of a tamper resistant power receptacle consistent with an exemplary embodiment of the present invention.

FIG. 2 is an exploded side elevation view of the upper portion of the tamper resistant power receptacle of FIG. 1

FIG. 3 is an exploded front perspective view of the lower portion of the tamper resistant power receptacle of FIG. 1 including a body and a socket assembly with a sliding socket and tine blade receivers.

FIG. 4 is a side elevation view of a first embodiment of the tine blade receiver.

FIG. 5 is side elevation view of a second embodiment of the tine blade receiver.

FIG. 6 is a cross sectional view of the socket assembly of FIG. 3 having a sliding socket in receipt of plural tine blade receivers.

FIG. 7 is a side elevation cross sectional view of the tamper resistant power receptacle taken along line 7-7 of FIG. 1 in a non-energized or neutral state.

FIG. 8 is a side elevation cross sectional view of the tamper resistant power receptacle taken along line 7-7 of FIG. 1 in an energized or powered state in receipt of a pair of plug blades.

FIG. 9 is a front perspective view of an alternative embodiment of the body of FIG. 3.

FIG. 10 is a front perspective view of an alternative embodiment of the socket assembly of FIG. 3.

FIG. 11 is a magnified cross-sectional view of the socket assembly of FIGS. 3 and 10 with a plug blade spaced above a first move lock system.

FIG. 12 is the magnified cross-sectional view of the socket assembly of FIGS. 3 and 10 in receipt of the plug blade.

FIG. 13 is the magnified cross-sectional view of the socket assembly of FIGS. 3 and 10 in receipt of an alternative object.

FIG. 14 is a magnified cross-sectional view of an alternative socket assembly with an alternative move lock system.

FIG. 15 is a magnified cross-sectional view of a second alternative socket assembly with a second alternative move lock system.

FIG. 16 is a magnified cross-sectional view of the second alternative socket assembly with a third second alternative move lock system of FIG. 15 in receipt of the plug blade.

FIG. 17 is a magnified cross-sectional view of an alternative junction box adapted for use with the first move lock system of FIG. 11.

FIG. 18 is a cross-sectional view of the alternative socket assembly of FIG. 10 adapted for use with the first move lock system of FIG. 11.

FIG. 19 is a front perspective view of a second alternative embodiment of the body of FIG. 3.

FIG. 20 is a front perspective view of a second alternative embodiment of the socket assembly of FIG. 3.

FIG. 21 is a magnified cross-sectional view of a second alternative junction box adapted for use with the second alternative move lock system of FIG. 15.

FIG. 22 is a cross-sectional view of the second alternative socket assembly of FIG. 20 adapted for use with the second alternative move lock system of FIG. 15.

FIG. 23 is a magnified cross-sectional view of a second alternative junction box adapted for use with the second alternative move lock system of FIG. 15.

FIG. 24 is a side elevation cross-sectional of a second alternative embodiment of the tamper resistant power receptacle taken along line 7-7 in FIG. 1 with the second alternative socket assembly of FIG. 22, the second alternative move lock system of FIG. 15 being depicted in a neutral state.

FIG. 25 is a side perspective view of an assembled twist lock receptacle.

FIG. 26 is an exploded side elevation of an assembled twist lock receptacle.

FIG. 27 is a front plan view of the twist lock receptacle of FIG. 25 with the twist receptacle components removed.

FIG. 28 is a side perspective view with of the twist lock with the cover removed.

FIG. 29 is a side elevation of an electrical plug inserted into twist receptacle.

FIG. 30 is a front perspective view of the twist lock receptacle of FIGS. 25-27 with the body compartment removed.

FIG. 31 is a front plan view of the twist lock receptacle of FIGS. 25-27 with the body compartment removed.

FIG. 32 is a partial-sectional view of an alternate embodiment of the twist lock.

FIG. 33 is a top plan view of the alternative embodiment of the twist lock of FIG. 32.

FIG. 34 is a side partial-sectional view of the twist lock of FIG. 32.

FIG. 35 is a transparent side elevation of the bottom cap.

FIG. 36 is a transparent side elevation of the body assembly.

FIG. 37 is a transparent side elevation of the socket assembly.

FIG. 38 is a side elevation of the extension cord receptacle components of FIGS. 35-37.

FIG. 39 is a side elevation of the top cap.

FIG. 40 is a top plan view of the top cap.

FIG. 41 is a top plan view of the socket assembly.

FIG. 42 is a schematic diagram of an alternative embodiment of a blade lock assembly.

FIG. 43 is a top plan view of the bottom cap.

FIG. 44 is a top plan view of an alternative embodiment of the plug receptacle with the end cover removed.

FIG. 45 is a top plan view of an alternative embodiment of the plug receptacle.

FIG. 46 is a bottom plan view of an alternative embodiment of the plug receptacle.

FIG. 47 is a top plan view of an alternative embodiment the top cap.

FIG. 48 is a side elevation of the top cap of FIG. 47.

FIG. 49 is a top plan view of the top cap of FIG. 47 assembled to the plug receptacle.

FIG. 50 is a magnified cross-sectional view of the top cap of FIG. 47.

FIG. 51 is a side perspective view of the alternative plug lock.

FIG. 52 is a side elevation view of the top cap of FIG. 47 assembled to the plug receptacle.

FIG. 53 is an exploded side elevation of an alternative embodiment of the tamper resistant power receptacle.

FIG. 54 is a top plan view of a body assembly of the tamper resistant power receptacle of FIG. 53.

FIG. 55 is a top plan view of a power block of the tamper resistant power receptacle of FIG. 53.

FIG. 56 is a cross-sectional view of a socket assembly of the tamper resistant power receptacle of FIG. 53.

FIG. 57 is a rear elevation of the power block of FIG. 55.

FIG. 58 is an end elevation of the power block of FIG. 55.

FIG. 59 is a top view of an alternative embodiment of a top cap.

FIG. 60 is an end elevation of the top cap from FIG. 59.

FIG. 61 is a sectional side elevation of an alternative slide lock.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 1 generally designates an embodiment of the improved tamper resistant power receptacle adapted for movement between a neutral and an energized state having three alternative embodiments as further identified below.

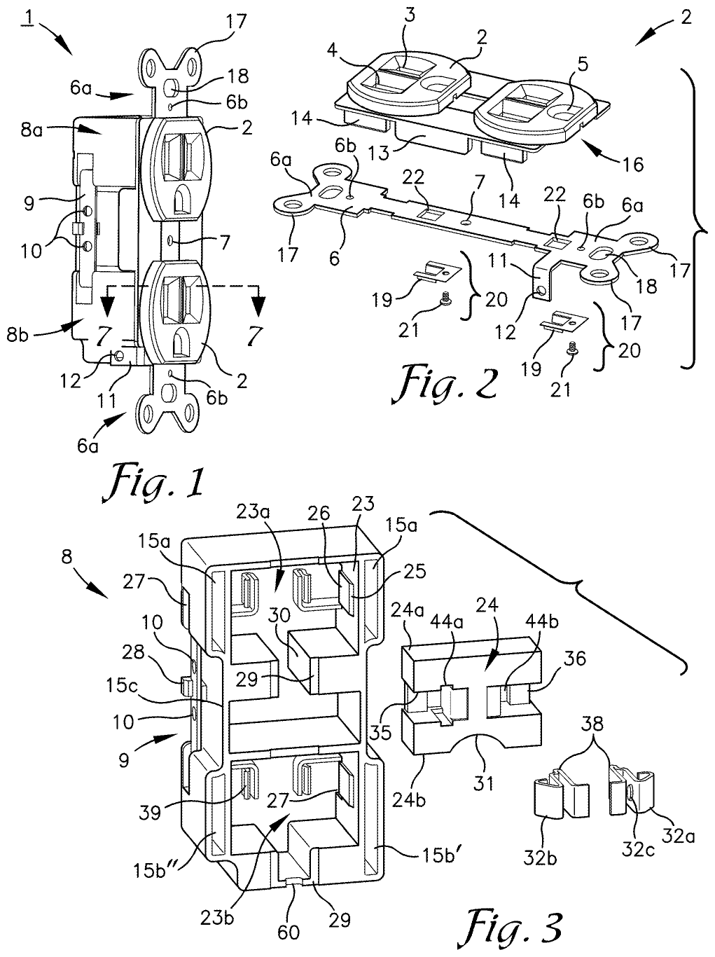

FIG. 1 shows an exemplary embodiment of the tamper resistant power receptacle 1. The arrow 7′-7′ identifies the direction of observance in the cross-sectional views of FIGS. 6, 7, 18, 19 and 24. The receptacle 1 is substantially the same size and shape of for receipt within a standard outlet enclosure or junction box (not shown). FIG. 1 includes a face plate 2 having at least one neutral receptacle 3 for receipt of the neutral tine (not shown), a live receptacle 4 for receipt of a live or hot tine (not shown), and a ground receptacle 5 for receipt of a ground tine (not shown), the neutral, live and ground tines being associated with a common three prong plug (not shown). A mounting frame 6 includes a pair of tabs 6a, each extending outwardly from an end of the faceplate 2 and allowing for mounting of the receptacle 1 within a standard electrical box (not shown). The mounting frame 6 may be fabricated from a single metal piece or may utilize various electrically conductive materials as needed to achieve the electrically conductive operation as further described below.

Each tab 6a of the metal mounting frame 6 has a threaded hole 6b for mounting a standard cover plate (not shown). A body 8 supports a pair of power buses 9 located on opposite sides of the receptacle 1, each power bus 9 has a plurality of threaded bus holes 10 for connecting to power supply wires (not shown) and receivers 39 (illustrated in FIG. 5) which are in switched communication with the power bus 9. Generally the first power bus presents a first electrical circuit leg and the second power bus presents a second electrical circuit leg. The electrical connection between the first and second electrical circuit leg is normally open in that there is no electrical connectivity between the two legs. However, during receipt of a standard plug associated with a resistance device like a household object requiring electricity (not shown) the sliding socket 24 moves from a first position to a second position completing the electrical circuit between the first power bus and the second power bus.

The mounting frame 6 has a downward extension 11 extending outwardly from the mounting frame along the body 8 and presenting a threaded neutral opening 12 for electrical communication with a ground wire (not shown).

The upper portion is depicted in FIG. 2 with the face plate 2 being shown in greater detail. Besides the receptacles 3-5 it has four tabs 14 that are adapted for receipt within body recesses 15 (FIG. 3), two external tabs 13 adapted to span between an upper and lower body regions 8a, 8b as illustrated in FIG. 1. A shaped recess 16 is extends downwardly from the face plate 2 between the pair of tabs 14 associated with the lower body region 8b. The shaped recess 16 provides for horizontal receipt of the mounting frame 6 while supported above the body 8 in the assembled receptacle. The shaped recess 16 has sufficient dimension for rectangular passage between the face plate 2 and a cover hole 7 associated with the mounting frame 6. When assembled the face plate 2 may be mechanically or chemically secured to the body 8 with for example mechanical or liquid fasteners.

As further depicted in FIG. 2, the illustrated embodiment of the mounting frame 6 includes a pair of ears 17 extending from the tabs 6a with an alignment structure 18 centrally disposed. In addition, the mounting frame 6 includes a pair of rectangular receivers 22, each rectangular receiver 22 is generally aligned with a rectangular contact 19 generally referred to as an independent contact 20. As illustrated in FIG. 2, the independent contact 20 is mechanically fastened with a threaded fastener 21, for example extending between the rectangular contact 19 and the mounting frame 6. In one embodiment of the present invention, the independent contact 20 may provide for independent grounding or independent electrical operation of each receptacle, allowing one receptacle to be operational while another is not.

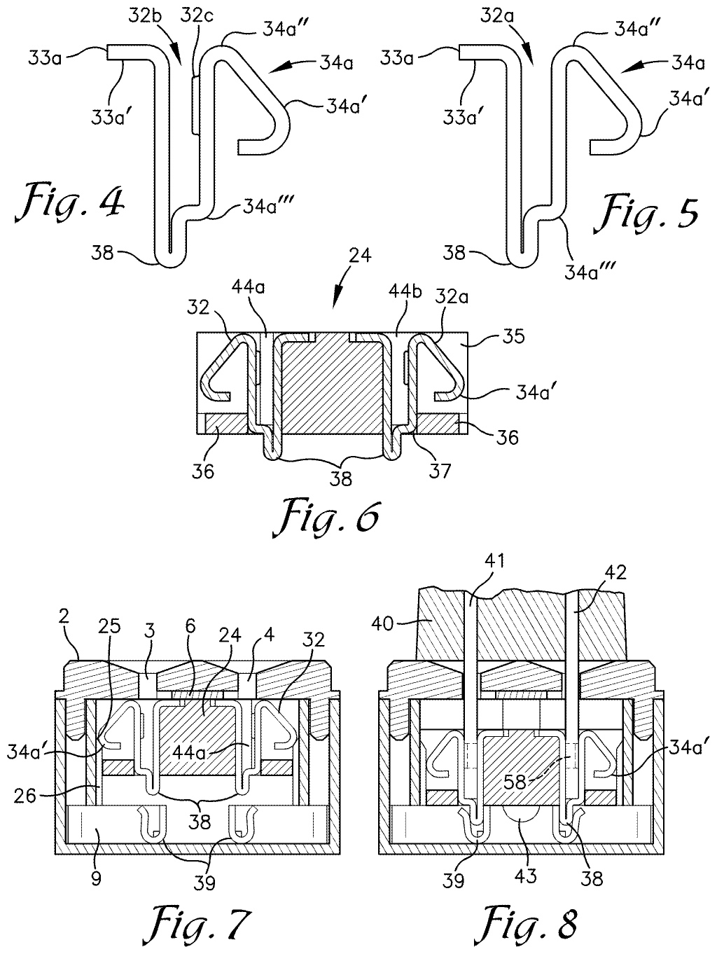

The general shape of a first embodiment of the lower portion with body 8, sliding socket 24 and tine receiver 32a and alternative tine receiver 32b being shown in FIG. 3. The body 8 includes a first and a second rectangular cavity 23a, 23b, the first rectangular cavity 23a associated with the upper body region 8a and the second rectangular cavity 23b associated with the lower body region 8b. The first rectangular cavity 23a is generally symmetrical with the opposing upper body recesses 15a being generally similar in shape and size. The second rectangular cavity 23b includes a pair of opposing lower body recesses 15b and is generally asymmetrical. In the embodiment depicted in FIG. 5, one of the body recesses 15b′ is larger than the opposing body recess 15b″, the shorter body recess 15b″ presenting an inwardly depressed region along a lower corner of the body 8. Along each longitudinal side of the body 8, a spanning depression 15c extends from the first and second rectangular cavity 23a, 23b, the pair of spanning depressions 15c adapted for receipt of the external tabs 13. An embodiment of a sliding socket 24 generally consistent with the embodiment of the illustrated body 8 of FIG. 5 is illustrated in FIGS. 3-4 with the sliding socket 24 being generally adapted for receipt within each of the first and second rectangular cavity 23a, 23b.

A short ramp 25 extends inwardly away from a sidewall 23 associated with each of the upper and lower rectangular cavities 23a, 23b. The short ramp 25 extends inwardly at an angle from the sidewall 23 and terminates at a ramp extension 26 which is generally parallel to the sidewall 23. Each cavity 23 includes two rectangular channels 27 extending beneath the ramp extension 26 from opposite sides of each upper and lower rectangular cavity 23a, 23b. The rectangular channels 27 allow for electrical communication with the power bus 9 therethrough. Each of the power bus 9 is secured to the body 8 with for example, external clips 28 located along the body 8. A central compartment 30 is positioned below and in communication with the first rectangular receiver 23a. Generally, the central compartment allows for the storage of additional electrical conduit (not shown) and may include a ground wire (not shown) for electrical connection to the ground receptacle 5, for example when a three prong plug (not shown) is inserted into one outlet of the receptacle 1. The body 8 includes a lower passage 60 extending outwardly through the second rectangular cavity 23b and may accommodate the passage of additional electrical conduit therethrough and for electrical operation of one of the independent contacts 20.

The sliding socket 24 adapted for receipt within the first and second rectangular cavities 23a, 23b is shown in FIG. 3. The sliding socket 24 generally includes an arcuate groove 31 extending between a pair of planar members on a top socket side 24a and the bottom socket side 24b presenting a generally planar surface. The arcuate groove 31 is generally adapted for passage of a ground tine (not shown) therethrough while the sliding socket 24 is received within the body 8. A pair of side recesses 35 are spaced apart and positioned between the top socket side 24a and the bottom socket side 24b with each being shaped to accommodate a tine receiver 32.

As further depicted in FIG. 3, the pair of side recesses 35 may each include a lower support structure 36 which is inset for secured receipt by the ramp extension 26 when the sliding socket 24 is received by one of the first and second rectangular cavities 23a, 23b. The lower support structure may optionally include a rectangular passage 37 through which one of a first or second tine receivers 32a, 32b may extend during receipt of a tine (not shown). The first or second tine receivers 32a or 32b may be secured mechanically or chemically, with for example glue adhesive.

As depicted in FIG. 3, the sliding socket 24 is adapted to receive a pair of tine receivers 32a. Either the tine receiver 32a or alternative tine receiver 32b may be received by the sliding socket 24.

FIGS. 4-5 show both the tine receiver 32a and the alternative tine receiver 32b, both including a first and second tine sidewall members 33a, 34a which present the first or second slot 44a, 44b adapted for receiving a standard plug blade (not shown) of a standard plug (not shown) so that plug blade (not shown) is passed easily through the first or second slot 44a, 44b along the first and second sidewall members 33a, 34a. The first sidewall member 33a presents a substantially horizontal lip 33a′ and then extends downwardly substantially perpendicularly to the horizontal lip 33a′ presenting a trailing end 38. The second sidewall member 34a presents an angularly dependent lip 34a′ which extends upwardly from a downward position towards a crest 34a″ in-line with the substantially horizontal lip 33a′ of the first sidewall member 33a and then extends downwardly parallel to the first sidewall member 33a towards a lower position 34a′″. At the lower position 34a′″ the second sidewall member 34a steps downwardly to join the first sidewall member 33a at the trailing end 38. Optionally and alternatively, one embodiment of the first tine receiver 32a may include a slotted member 32c extending from the first sidewall member 33a towards the second sidewall member 34a, the slotted member 32c being adapted for receipt within a tine hole (not shown) in a plug blade (not shown) when received by one of the neutral, live or ground receptacles 3, 4, 5. The first and second sidewall members 33a and 34a are generally spaced for receipt of a standard plug blade (not shown) so that insertion of a plug (not shown) is not impeded.

A first slot 44a is depicted in FIG. 6 and is generally adapted for receipt of a live or hot tine (not shown). A second slot 44b is depicted in FIG. 6 and is generally adapted for receipt of a neutral tine (not shown). In a polarized plug (not shown) the live or hot tine is generally wider than a neutral tine (not shown) and in connection with receipt of a polarized plug, in an alternative embodiment, the first slot 44a will be sized accordingly as is generally known. Upon receipt by each of the first and second slots 44a, 44b of a standard plug blade (not shown) the trailing end 38 of the first sidewall member 33a is extended downwardly towards the power bus receiver 39 forming an electrical circuit which energizes the sliding socket 24. In one embodiment, the trailing end 38 of the first sidewall member may be frictionally retained while energizing the sliding socket 24.

The working elements of the tamper resistant power receptacle 1 are shown in FIGS. 7 and 8. FIG. 7 is a section view of the tamper resistant power receptacle 1 in an un-energized or unpowered state. Generally, the angularly depending lip 34a′ of the sliding socket 24, causes interference with the short ramp 25, limiting electrical contact between the trailing end 38 and the power bus receiver 39. As shown in FIG. 7, generally, the first and second sidewall members provide moderate resistance to compression by the short ramp 25, thus resisting the sliding motion of the sliding socket 24.

As shown in FIG. 8, when a plug 40 (shown truncated, with neutral tine 41, hot tine 42, and ground tine 43) is inserted into the sliding socket 24, the user may exert a downward force on the plug 40 to overcome the resistance exerted by the angularly depending lip 34a′ and the short ramp 25. Under the downward force, the angularly depending lip 34a′ compresses inwardly and slides down the short ramp 25 and ramp extension 26, and positioning the trailing end 38 into electrical contact with the power bus receivers 39 as shown in FIG. 8.

When the plug is retracted the sliding socket 24 retracts, breaking electrical contact between the power bus receiver 39 and the trailing end 38. When the sliding socket 24 reaches the top of its travel the angularly depending lip 34a′ is positioned on top of the short ramp 25 in a decompressed state allowing plug 40 to be easily removed.

The resistance provided by the compression of the tine receiver 32 as it moves downwardly along the short ramp 25 provides resistance and additional protection against unintentional energizing of the sliding socket 24 during receipt by the sliding socket 24 of undesired objects. Things commonly available to a child such as paper clips, hair or safety pins, or wires and needles do not have handles and would be difficult to push hard enough to overcome the resistance to slide the socket to power.

The addition of a movement lock to prevent the sliding to power unless the two power tines of a plug are in the socket greatly increases the safety factor. The potential movement locks are shown in FIGS. 11-16 schematically with and without a “tine.” FIG. 14 illustrates an example of when the elastic limit of ordinary spring wire is reached and the spring associated with the depicted movement lock is deformed.

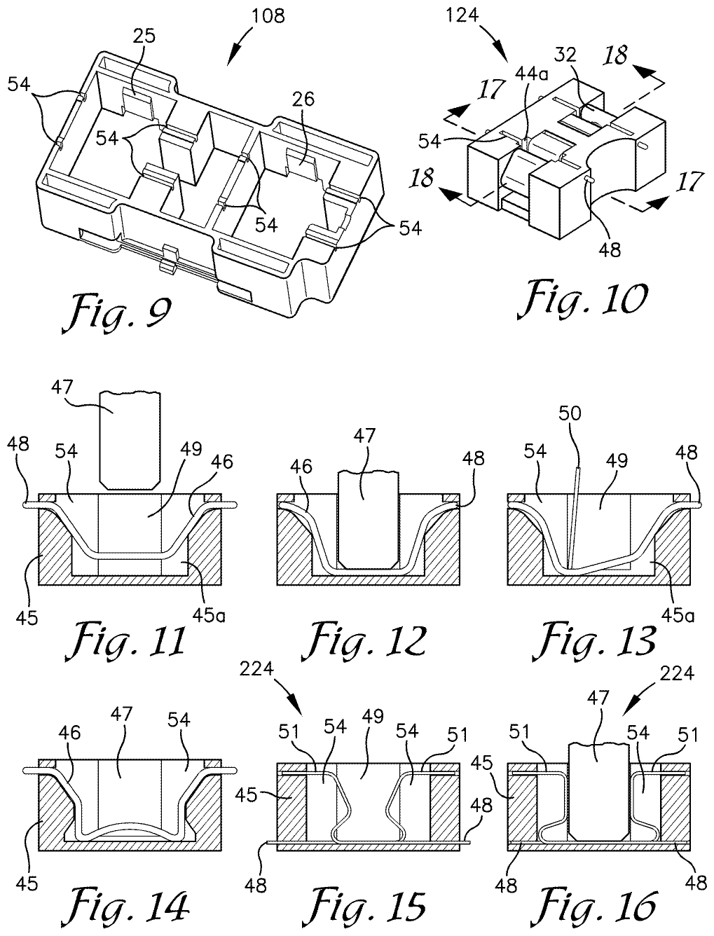

FIG. 9 illustrate an alternative body 108 adapted for use with an alternative sliding lock 124 illustrated in FIG. 10. The alternative body 108 generally has the same structure as previously described in association with body 8 in FIG. 3. The alternative body 108 in FIG. 9 includes a plurality of slots 54 which are each adapted for receipt of resilient member 48 associated with the alternative sliding lock 124 depicted in FIG. 10. As illustrated in FIG. 9 the alternative body 108 includes upper and lower recesses which are adapted for receipt of the alternative sliding lock 124 and a short ramp 25 and ramp extension 26 which support and provide resistance during movement of the alternative sliding socket 124 between an un-powered state and an energized condition. Generally, the slots 56 are parallel to each other and extend through the upper body region 8a and the lower body region 8b and are adapted for receipt of the resilient member 48.

FIG. 10 includes the alternative sliding lock 124 which includes a pair of resilient members 48. Generally, the pair of resilient members 48 extends from the top socket side 24a to the bottom socket side 24b, one of the pair of resilient members 48 extending through the first slot 44a and the other one of the pair of resilient members 48 extending through the second slot 44b associated with the alternative sliding lock 124. The first and second slots 44a, 44b are generally adapted for receipt between the first sidewall member 33a and the second sidewall member 34a associated with one of the tine receivers 32a, 32b. The spacing between the first and second sidewall members 33a, 34a is sufficient for moveable receipt of each of the resilient members 48. During receipt of the resilient member 48, the alternative sliding socket 124 has sufficient dimensions to position the resilient member 48 near but not electrically connected to the power bus 9 while the sliding socket is in the un-energized state. Movement to the energized state from the un-energized state during tampering is obstructed by the pair of resilient members 48 received by the first and second sidewall members 33a, 34a.

The alternative sliding socket 124 illustrated in FIGS. 11-13 are adapted for use with the receptacle depicted in FIGS. 9-10. This receptacle utilizes the items described in FIG. 2 and the same tine contacts 32 and 33 shown in FIG. 3 as the previously described receptacle.

The alternative sliding socket 124 has the same general form as sliding socket 24 of FIG. 3, but has two socket slots 56 generally parallel to and extending across the first and second slots 44a and 44b for access to resilient member 48, and two passages 57 for reciprocal passage of the ends 46 extending distally from the resilient member 48 as needed for movement of the alternative sliding socket 124 within the alternative body 108 between the powered and unpowered position. The socket slots 56 are wide enough to allow for reciprocal and projected movement of the resilient member 48 as further described herein. The shape and position of the socket slots 56 and passages 57 are best seen in FIGS. 9 and 10.

FIG. 10 illustrates the pair of tine receivers 32a received within the first and second slots 44a, 44b of the alternative sliding socket 124. During receipt of the alternative sliding socket 124 by the alternative body 108, the ramp 25 interacts with the angularly depending lip 34a′ for movement between the energized and un-energized state.

As depicted in FIGS. 11-17, when a standard plug blade (not shown) is inserted into the alternative sliding socket 124, a pair of member ends 46 of the resilient member 48 being pressed against a pocket 45a associated with at least one of the first and second slotted member 44a, 44b. The first resilient end 46 retracts upon pressing the resilient member 48 into the pocket 45a, allowing the alternative sliding socket 124 to move down toward the energized or powered state. In one embodiment, fatigue of the alternative sliding socket 124 may be avoided by using material for the resilient member 48 which requires a less force to retract the resilient member 48 than to compress the first tine receiver 32a. During operation, the first tine receiver 32a remains compressed until the alternative sliding socket 124 is returned to its upper position, so the member end 46 of resilient member 48 may avoid unnecessary contact during movement along the sidewall 23. Upon movement of the sliding socket 24 or the alternative sliding socket 124 to the energized position, the power bus 9 energizes a received live receptacle (not shown) until movement away from the energized position.

FIGS. 11-13 present various cross sections of the alternative sliding lock 124 which are adapted for receipt of a plug blade 47 having a flat bottom positioned above the alternative sliding lock 124 in FIG. 11, received within the alternative sliding lock 124 in FIG. 12 and an exemplary foreign or tampering object 50 in FIG. 13. In operation, as the plug blade 47 is inserted between the first and second sidewall members 33a, 34a, the plug blade 47 presses against the resilient member 48 causing the member ends 46 to retract into the alternative sliding socket 124. When the member ends 46 retract inwardly, the alternative sliding socket 124 may move downwardly from the un-energized state to the energizing state.

FIGS. 11-12 illustrate the alternative sliding lock 124 which may be movable in either a linear or rotational direction, where the movable lock 124 is held in a fixed position by the member ends 46 of the resilient member 48 which may engage the alternative body 8 at a pair of slots 54 or engaging holes (not shown). The alternative sliding lock 124 is moved from an un-energized state to an energized state by inserting the flat surfaced plug blade 47 between the first and second sidewall members 33a, 34a and directing the resilient member 48 distally towards the pocket 45, both member ends 46 of the resilient member 48 being retracting inwardly.

When the foreign object 50 presses against the resilient member 48 it may cause an insufficient distortion or an asymmetrical distortion to the resilient member 48 to free the alternative sliding lock 124 for movement. As illustrated in FIG. 13, the foreign object 50 presses angularly against the resilient member 48, in a non-symmetrical manner which retracts only one end of the member ends 46. Because one of the member ends 46 is still protruding outwardly, the alternative sliding lock 124 is not able to move from the un-energized to an energized state.

FIG. 14 shows a second alternative sliding socket 224 which includes an irregular pocket 245 and alternative resilient member 248 having an arch caused by insufficient elasticity in the composition of the resilient member 248 because it exceeded the elastic limit of ordinary spring wire. In operation, it may be more desirable to use a material having sufficient elasticity such as memory metal to maintain the desired configuration during receipt of the plug blade 47.

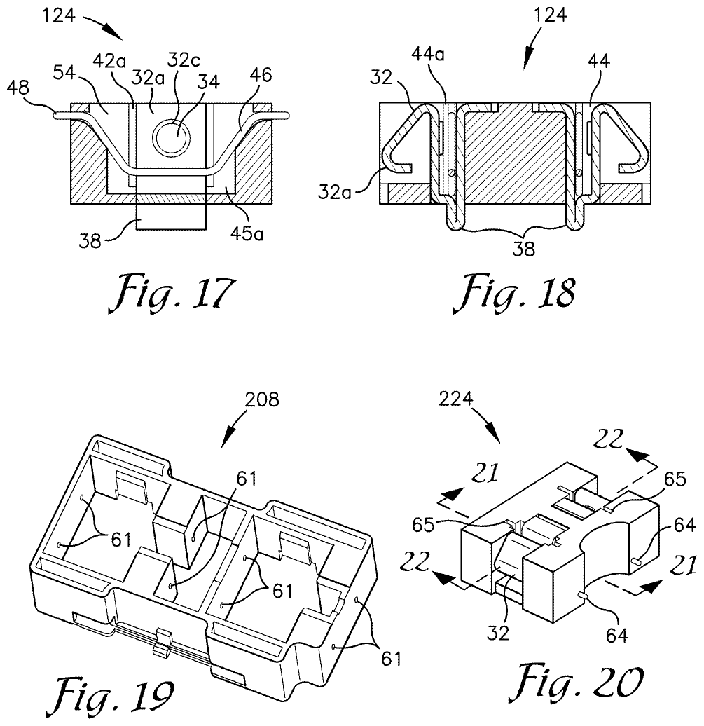

FIG. 17 depicts the second alternative socket 224 utilizing the alternative tine receiver 32b which is adapted for receipt of a plug blade having a circular dent 34. The second alternative socket includes a slot 65 which is generally less than the first or second socket 44a, 44b dimension but adapted for receipt of the plug blade 47 which may be polarized or unpolarized as desired. The pocket 45, being adapted for the received resilient member 48 is greater than the slot 65 but generally narrower than the first or second slot 44a, 44b in FIG. 17.

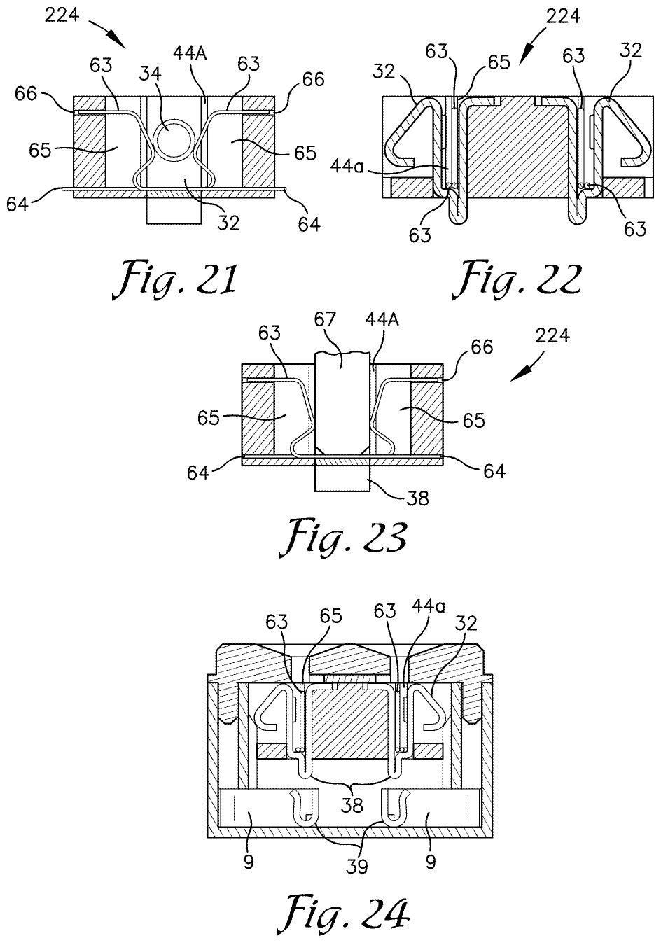

FIGS. 15-16, 18-25 illustrate a third alternative sliding lock 324 which has a second alternative pocket 345 and second alternative resilient member 348. The second alternative pocket 345 in combination with the second alternative resilient member 348 present a passage 354 which requires a plug blade having sufficient width to cause the member ends 346 to retract inwardly.

The third alternative sliding lock 324 beginning at FIG. 15 is adapted for receiving a pair of resilient members 348, each having an upper end 346a and a lower end 346b. Each resilient member 348 has a generally S-shaped configuration, extending from an upper outward protrusion to a lower outward protrusion associated with the outer surface of the third alternative sliding lock 324. In this configuration, utilizing too narrow a plug blade would not allow the member ends 346 to retract sufficiently as depicted in FIG. 15. Having a too wide a plug blade would not fit within the sidewall of the second alternative pocket 345. Having a proper spaced plug blade as illustrated in FIG. 16 allows for retraction of both the upper and lower protruding ends 346a, 346b of the alternative resilient members 348. Therefore, the movement of the third alternative sliding lock 324 between an un-energized condition to an energized condition may be limited based upon receipt of a properly mated plug blade. Therefore, as illustrated in FIGS. 15-16, 18-24, one aspect of the current invention presents a an opportunity to “key” a receptacle where only plug blades keyed for the specific sliding lock will allow movement of the sliding lock to power a properly configured plug. FIG. 18 depicts the third alternative sliding socket 324 as depicted in FIGS. 15-16 in receipt of the alternative tine receiver 32b.

FIG. 19 illustrates a third alternative body 308 adapted for receipt of the third alternative sliding socket 324 further illustrated in FIG. 20 with the lower ends 346b protruding through the third alternative sliding socket 324 in an un-energized condition as further described above. The third alternative body 308 includes eight circular slots 354 for receiving the ends of the resilient members 346a, 346b during the un-energized condition. These circular slots 354 are generally adapted for receipt of the resilient members 348, and are strategically placed so that when the third alternative sliding socket 324 is suspended above the power bus receiver 39 on the ramps 25 by the angularly depending lip 34a′. As with the previous receptacle, the resistance in retracting the resilient member's ends 346a, 346b when receiving a standard plug blade (not shown) allows for compression of either the first tine receiver or the second tine receiver 32a, 32b. Thus when the third alternative sliding socket 324 moves downward, the upper and lower ends 346a, 346b are retracted into the third alternative sliding socket 324 before downward movement of the socket 324 begins and retained until the socket 324 is lifted as the standard plug blade (not shown) is pulled out. If a foreign object such as a small screw driver is used to try to slide the socket 324 towards an energized condition, the upper and lower ends 346a, 346b at least partially prevent the socket 324 from moving while the angularly depending lip 34a′ is still engaged by the ramp 25. The resiliency of the first or second tine receiver 32a, 32b at least partially assist the third alternative sliding socket 324 to return to the un-energized position when pressure is released.

FIGS. 19-24 illustrate an embodiment of the tamper resistant safety receptacle which employs the third alternative sliding socket 324. The third alternative sliding lock 324 is adapted for the width of standard plug blades (not shown). Generally, two objects would not unlock the third alternative sliding socket 324 unless they were of the desired width and thickness. The resilient members 348 are generally received within the slots 65 parallel to the first and second slot 44a, 44b, spaced laterally. Each resilient member 348 is adapted to protrude through the third alternative sliding socket 324 opposite and in line with its slot. Upon the insertion of a standard plug blade (not shown) the neutral and live tines direct the resilient members 348 to retract the upper and lower ends 346a, 346b inwardly towards the third alternative sliding socket 324 for downward movement to the energized condition.

FIG. 24 illustrates a side sectional view of the third alternative sliding socket received by the third alternative body 308 in an un-energized or unpowered state. Generally, the angularly depending lip 34a′ of the third alternative sliding socket 324, causes interference with the short ramp 25, limiting electrical contact between the trailing end 38 and the power bus receiver 39. The power bus has complementary receiving structure for electronic coupling with the trailing end 38. As depicted, they include a pair of opposite facing arcuate receivers adapted for receiving and releasing the trailing ends 38 as the third alternative sliding socket 324 moves between the energized and un-energized state.

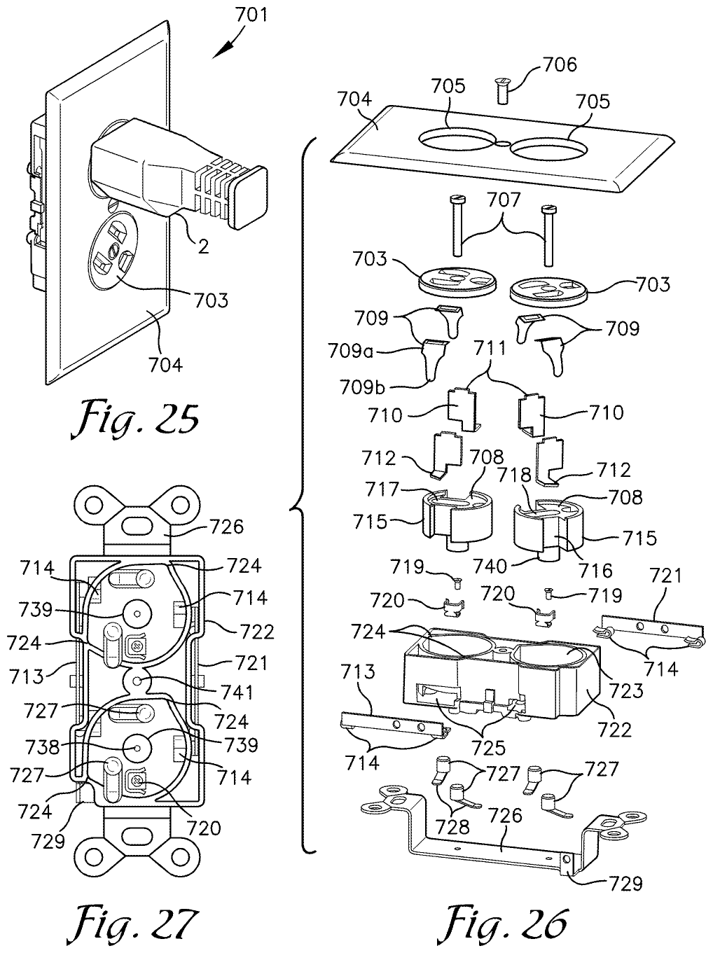

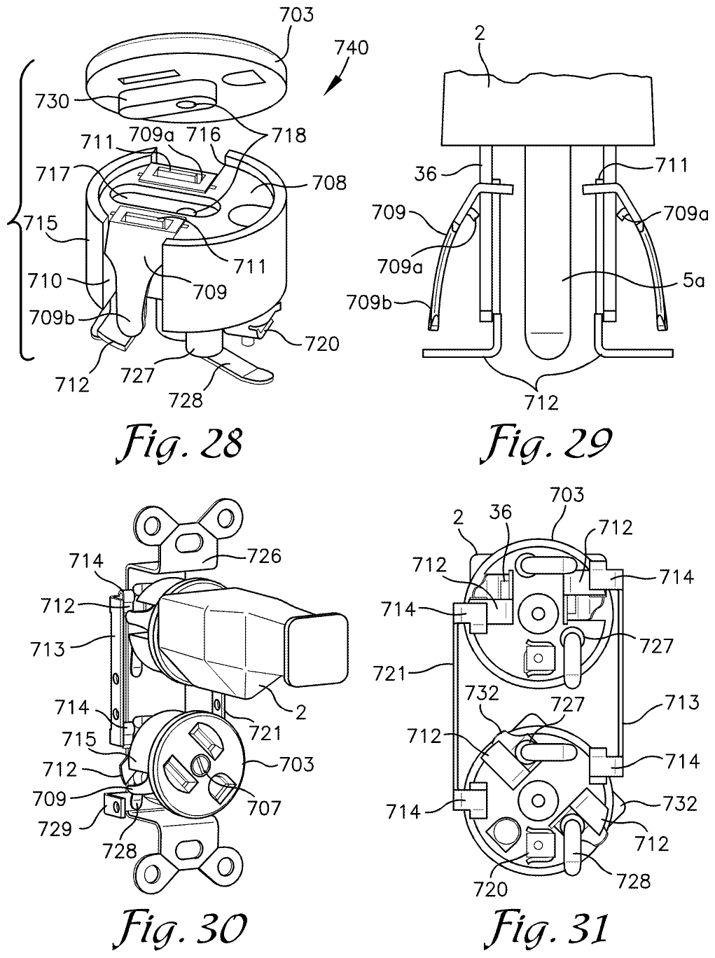

FIG. 25 shows an alternative embodiment of a rotary tamper resistant power receptacle 701 with cover plate 704. The rotary receptacle 701 is substantially the same size and shape for receipt within a standard outlet enclosure or junction box (not shown). The alternative rotary receptacle 701 contains a plurality of rotary sockets 725 each including a socket cover 703. Each rotary socket 725 is accessible through the cover plate 704 and is further illustrated in FIG. 28. The rotary socket 725 contains a socket cover 703 with a socket protrusion 708 extending downwardly from the socket cover 703 and central socket base 708. As shown in FIG. 25, each socket cover 703 may be turned to a rotated position from a non-rotated position. In the unrotated or normal position the socket cover 703 does not allow for electrical connectivity with the live and neutral power bus 713, 721.

A standard electrical plug 702 may be inserted into the rotary socket 725 at the socket cover 703 and used to rotate the rotary socket 725 from the normal associated with an unpowered condition to the rotated position associated with a powered condition in which the lie and neutral powered busses 713, 721 are in electrical communication with the device associated with the standard electrical plug 702. The rotation may be clockwise or counter clockwise as desired. Once rotated to the energized or powered position, electrical connectivity may be achieved and power may be supplied to the electrical plug 702 associated with device and power may be supplied thereto.

During operation, a standard plug 702 with plug blades 736 may be inserted into the rotary socket 725. Once inserted, the received plug blades unlock the rotary lock associated with the rotational pins 727 allowing the rotary socket 740 to be rotated from an unpowered condition to the powered condition. Once rotation of the rotary socket 725 begins, the locking spring 709 secures the plug blades 736 as the rotary socket 725 is rotated or while it is positioned in the energized position. Rotation of the rotary socket 725 to the powered condition rotates the central socket base 708 for electrical communication between the received plug blades 736 and the neutral and live power busses 713, 721. Different locking mechanisms prevent undesired rotation of the rotary socket 725 to the energized position and therefore inhibit undesired electrical communication. For example, this may occur when rotation of the rotary socket 725 is attempted without using a standard plug. The springing lock 709 secures and limits removal of the received plug blades 736 during rotation and during electrical communication with the live power bus 713 and neutral power bus 721.

FIG. 26 is an exploded view of the alternative rotary receptacle 701. Rotational pins 727 mechanically engage the central socket base 708 and include an outwardly extending handle 728. Each handle 728 secures each rotational pin 727 to the mounting frame 726. Each socket base 708 incudes a socket base 715 with a plurality of socket base recesses 716 each one being generally located on opposite sides of the socket base 715 and adapted to receive one of the rotational pins 727. Each handle 728 includes an upwardly extending distal end opposite the rotational pin 727. The rotational pin 727 is generally adapted for receipt by the socket recess 716 and is secured to the mounting frame 726 by the handle 728. Each socket base recess 716 is also adapted to receive a blade contact 710.

In the embodiment depicted in FIG. 26, each blade contact 710 includes a two part interlocking structure adapted for receipt by the socket base recess 716 and extending from a proximal tab 711 to a perpendicularly located distal tab 712. The two part interlocking structure associated with the blade contact 710 helps prevent undesired rotation of the central socket base 708 while assisting in electrical communication.

The face plate 704 contains openings 705 which allow for exposure of the rotary sockets 725 at the socket covers 703. Face plate 704 is mechanically fastened to the body 722 with, for example, screw fasteners 706 threadably received by a threaded body hole 741. Oppositely spaced locking springs 709 extend below the socket cover 703 and each include a slotted opening 709a and a depending lip 709b. Generally, each of the locking springs 709 overlies each blade contact 710 and is shaped for receipt within a channel associated with the socket base recess 716.

As illustrated further in FIG. 28, the slotted opening 709a is designed to receive the proximal tab 711 and the depending lip 709b is designed for engagement with the distal tab 712. As further described below, the slotted opening 709a also receives of the plug blade 736.

FIG. 27 is a top view of the alternative rotary receptacle 701 with the face plate 704 removed. The body 722 is mechanically fastened to the mounting frame 726 and as depicted in the embodiment illustrated in FIG. 27, utilizes the ground connectors 720 for this purpose. The body 722 contains a circular sidewall 723 with a plurality of body recesses 724. The circular sidewall 723 is generally adapted for receipt of the assembled sockets 740. When the assembled sockets 740 are installed in the body 722, in the unpowered, unrotated position, the blade locking springs 9 are generally oriented towards the body recesses 724. When the assembled socket 740 is in the unrotated, unpowered position, the blade locking springs 709 work in communication with the body recesses 724 to maintain the unrotated unpowered position. When a standard electrical plug 702 is inserted into the rotary socket 725, each plug blade 736 comes into communication with an interlocking blade contact 710.

Each locking spring 709 includes the depending lip 709b on the distal end and a leaf 731 angularly extending inwardly from the proximal end. Generally, the leaf 731 presents an outward bias upon the depending lip 709b. When a standard electrical plug 702 with plug blades 736 is received by the socket 740, the plug blade 736 passes through the slotted opening 709a and between leaf 731 and the blade contact 710, the plug blade 736 outwardly engages the depending lip 709b into the body recess 724 while the rotary socket 701 is in the unpowered position. The locking springs 9 surround the blade contacts 10 and the plug blade 736. When the plug 702 is inserted into the socket 725 it passes between the blade contacts 10 and the leaf 709a. As the plug blade 736 continues downward, it engages the rotational pins 727 for placement below the recesses 716 for rotation of the socket 740.

When rotation begins, the depending lip 709b moves from the body recess 724 and is compressed by the circular sidewall 723. The compression of the depending lip 709b exerts pressure against and engages the plug blade 736 against the blade contacts 710 to provide for stable electrical communication between the rotary socket 740 and the plug blade 736 and to prevent retraction of the plug blade until the rotary socket 740 returns to the unpowered condition, when the depending lip 709b is realigned with the body recess 724.

When the rotary socket 740 is rotated to the powered condition, the distal tab 712 is received within a power connector 714 also referred to herein as a switch receiver associated with each of the live and neutral power busses 13, 21. Each of the busses 713, 721 are secured to the body 722 with each power connector 714 positioned within the body recess 724 for electrical connectivity upon rotation to the powered condition or state. The live power bus 713 runs tangentially along the body recesses 724 parallel to neutral power bus 721 which also runs tangentially along the body recesses 724. The distal and proximal ends of each live power bus 713 and neutral power bus 721 are attached to the power connector 714 and adapted for receipt of the distal tab 712 extending from the rotational pins 727 when the rotary socket 740 is rotated to the powered state.

FIG. 28 depicts and exemplary assembled socket 740 having socket base 715 spaced from the socket cover 703. Each socket base 715 has at least two socket base recesses 716, a top generally circular recess 708 for receiving the socket cover 703 and a central recess 717. A pivot hole 718 in socket base 715 is located within central recess 717 and is generally adapted for receipt of a mechanical fastener used to secure the socket cover 703 to the socket base 715.

FIG. 29 illustrates an exemplary plug 2 with plug blades 36 and ground tine 5a in association with an embodiment of the locking spring 709. The locking springs 709 has a downwardly depending lip 709b and a leaf 709a. When a standard plug blade 736 is inserted through the rotary socket 740, each of the plug blades 736 is pressed between the leaf 709a and the blade contact 710. As the plug blade 736 passes along the blade contact 710, the plug blade 736 engages the leaf 709a and outwardly extends the downwardly depending lip 709b of the locking springs 709. When the rotary socket 740 is positioned in the unrotated position, the locking spring 709 extends into recess 724 of the body 722. When the plug blade 736 is fully inserted, the locking pins 727 are pressed down below the recesses 716, allowing the rotary socket 725 to be rotated.

During rotation, the downwardly depending lip 709b moves away from recess 724, the circular sidewall 23 applying an inward pressure against the locking spring 709. This inward pressure against the leaf 709b secures the plug blades 736 and the blade contacts 710 during rotation to the powered state, locking the plug blades 736 into the socket 740. Continued rotation slips the distal tabs 712 into the power contacts 714 on the ends of the power buses 713 and 721, thus providing electrical power to the received plug 702.

The socket base recesses 716 are adapted for receipt of the blade contacts 710 and the locking springs 709. Upon this receipt, the proximal tab 711 protrudes into the top recess 708. The blade contacts 710 are located between the socket base 715 at the socket base recess 716 and the locking springs 709. The locking springs 709 are secured on proximal tab 711 at slot 709a, the locking spring 709 being secured to the blade contact 710. The socket cover protrusion 730 is adapted for mated engagement with the central recess 717 and is generally positioned to align the orientation of the socket base cover 703 with the socket base 715. A As previously mentioned, a mechanical fastener such as, but not limited to, the socket fastener 707 may be used in communication with pivot hole 718 to affix socket base 715 to mounting frame 726. During operation, the locking springs 709 pivot within the socket base recess 716 providing reciprocal lateral movement of the proximal tabs 711 within the socket base recess 708.

FIG. 30 illustrates the rotary receptacle with the cover plate 704 and body 722 removed to better illustrate the rotary socket 740 in the powered and unpowered condition. As illustrated, in FIG. 30 the bottom rotary socket 740 is in the un-rotated, unpowered position and the upper rotary socket 740 is in receipt of a standard plug and rotated to the powered position. As illustrated, upper rotary socket 740 is rotated to the powered position and the distal tabs 712 associated with the blade contact 710 are engaged to the switch receiver 714. The lower rotary socket 740 is un-rotated and the distal tabs 712 are spaced from the switch receiver 714 in the unpowered position.

FIG. 31 shows the electrical communication between the opposite spaced live and neural power busses 713, 721 along the body 722. The body 22 supports the live power bus 713 and the neutral power bus 721 each bus being adapted for electrical connection to an external power source (not shown). The ends of each power bus 713, 721 includes a positive and a negative switch receiver 714 adapted for receiving the distal tabs 12 associated with the socket blade contacts 10. In this way, the rotation of the socket 740 rotates the distal tabs 12 into the switch receivers 714 consistent with the power condition for providing neutral and live power to the received plug blades 736.

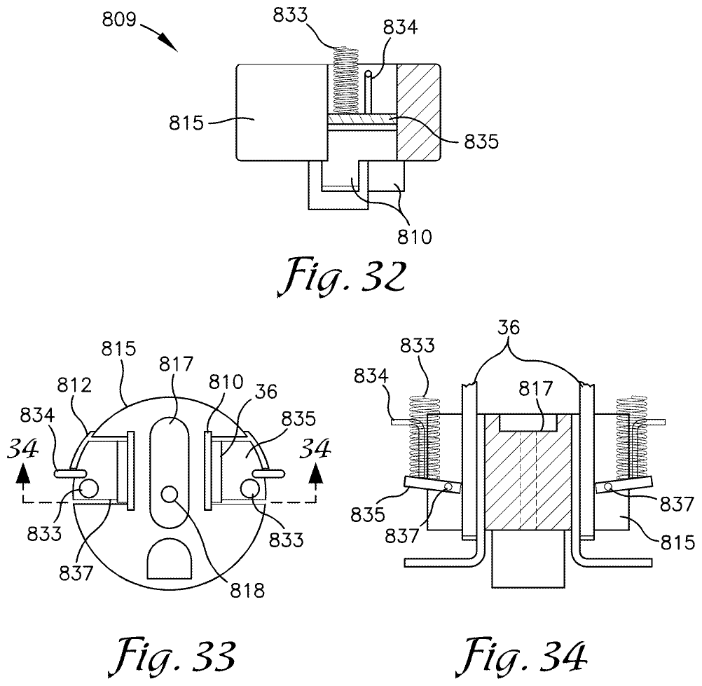

FIGS. 32-34 show an alternative locking spring mechanism 809 which utilizes a elastic member to outwardly bias the alternative locking spring 809. The alternative locking spring mechanism 809 is beneficial for child safety and to avoid plug pull-out difficulties. In connection with the alternative locking spring mechanism 809, an alternative rotary socket base 815 is utilized which generally has similar structure to the previously discussed rotary socket base 715 with a surrounding wall 823 but does not include a central recess. In addition, an alternative blade contact 810 is utilized in the alternative locking spring mechanism 809 which is a single contact having a distal tab 812.

The alternative locking spring mechanism 809 uses a plurality of locking bars 835 that are pivotally mounted in the socket base recesses 716 with a pivoting means 737. Control rods 834 are mounted to the surrounding wall 823 so that they are perpendicular to the locking bars 835. The alternative locking spring mechanism 809 moves from a powered to an unpowered position. In the unpowered position, the control rods 834 are angularly positioned on the locking bars 835 in an uncompressed state with the locking bars 835 beings spaced from and electrically separated from the alternative blade contact 810. When a standard plug blade 736 is inserted, the rotary socket 740 is rotated, the controls rods 834 are rotated towards the alternative blade contact 810 and the compression springs 833 are compressed by the socket cap 703. In the powered position, the plug blades 736 are secured against the alternative blade contact 810 by the compressed compression springs 833 for electrical communication therebetween. When the rotary socket 735 is rotated to the unpowered position, each control rod 834 is counter rotated as the compression spring 833 becomes uncompressed and the control rod 834 engages the locking bar 834, raising the control rod 834, rotating the locking bar 835 away from the plug blade 736 for removal of the plug 702.

In connection with the alternative locking spring mechanism 809, the body 822 utilizes a bi-level socket sidewall 823 so that when the socket 740 is rotated to the powered position the control rods 834 may be spaced from the locking bars 835 for rotation without contact with the socket sidewall 823. Generally, the locking bars 835 have a similar function to the body recess 724 previously discussed.

Compression springs 833, are attached to the socket base 815 and are tangential to the locking bars 835. The socket cover 703 compresses the compression springs 833. The control rods 834 hold the locking bars 835 in a rotated position. When an electrical plug 702 is inserted and rotated to the vertical position, the compressions springs 833 rotates the locking bars 835 into contact with plug blades 736. Further rotation causes the plug blades 736 to contact the alternative blade contacts 810 to power the rotary socket 740. When the rotary socket 740 is in the rotated position, the control rods 834 raise the locking bars 835 away from the plug blades 736 so that the plug 702 may be removed.

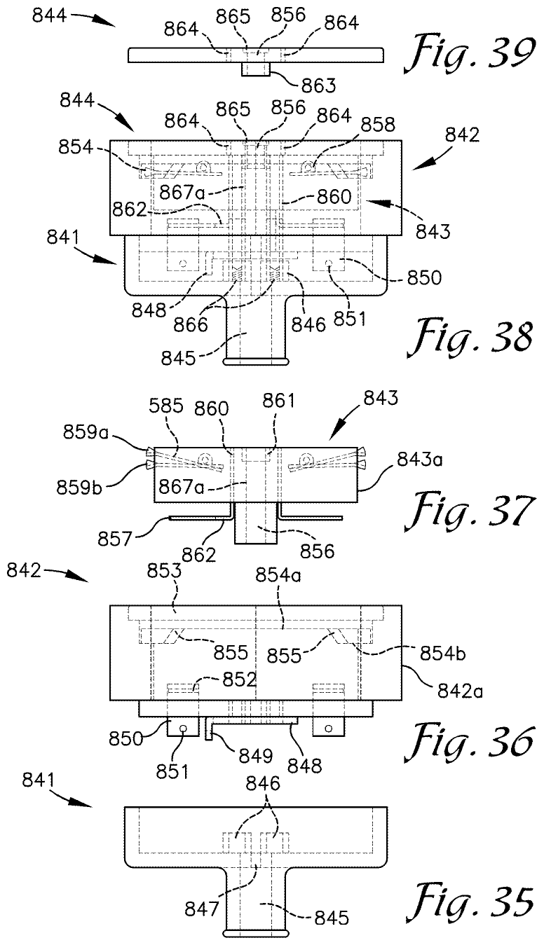

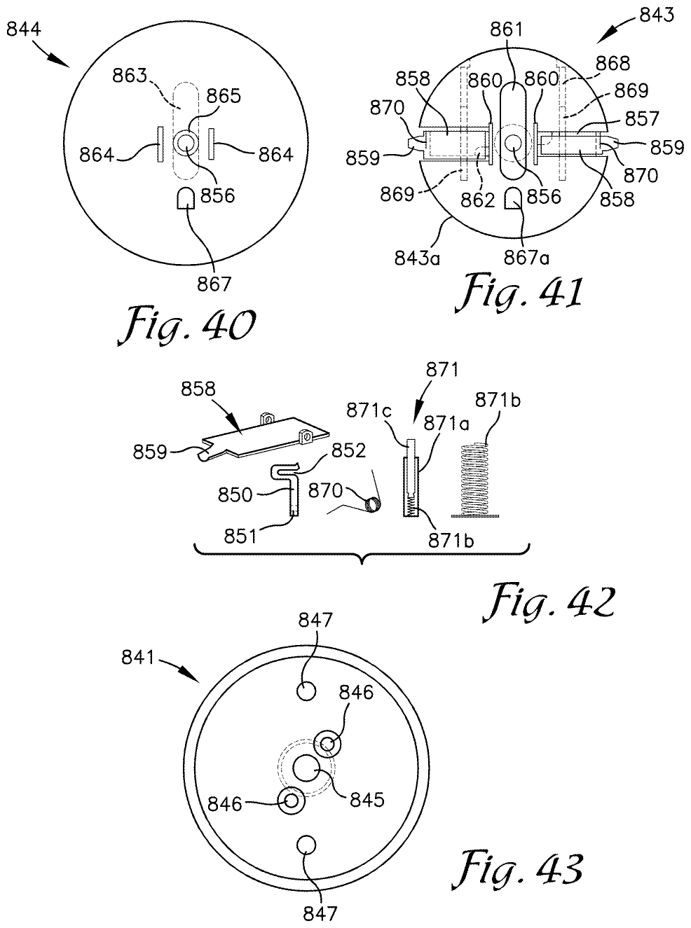

FIGS. 11-28 show an embodiment of the present invention utilizing tow aspects of the alternative locking spring mechanism 809 adapted for use as an extension cord. The main components of the extension cord application are a bottom cap 841 (further illustrated in FIGS. 35, 43) and a top cap 844 (further illustrated in FIGS. 39-40) attached to a body assembly 842 (further illustrated in FIGS. 36, 44, 46). The body assembly 842 is adapted for receipt of a socket assembly 843 (further illustrated in FIGS. 37, 41).

The bottom cap 841 contains a wire receiver 845 which is adapted for receiving a standard sized wire. The bottom cap 841 also contains two attachment holes 847 which are used to attach a base 848 to the bottom cap 841. The base 848 also utilizes a ground connection 849. A plurality of tubular projections 846 are attached to the base 848 and protrude outwardly toward the bottom cap 848. The tubular projections 846 contain central twist locks 871 (further illustrated in FIG. 42).

The twist lock 871 is shown in detail in FIG. 18. Each twist lock 871 consists of a tube 871a adapted for receiving a spring 871 band a pin plunger 871c. The pin plunger 871c is adapted for fitting inside the proximal end of the spring 871b. Groves in the side of the pin plunger 871c allow for retention of the pin plunger 871c by the spring 871b. The bottom turn of the spring 871b at its distal end is larger in diameter than the tube 871a so that when the twist lock 871 is installed into the tube projection 846 at the bottom cap 848 the bottom turn of the spring 871b, plunger 871e is retained by the tube 871a.

The bottom turn of the spring 87 ibis slightly larger than the outside diameter of tube 871a so that when the twist lock unit is installed into the tubular extensions 846 in the bottom cap 841, the larger turn of spring 871b lies under metal tube 871a thus retaining the spring 871b and plunger 871c in the tubular extension 846. An enlarged picture of spring 871b showing its structure is presented in FIG. 42. A friction fit of the tube 871a in the bottom cap tubular projections 46 retains the twist locks 71.

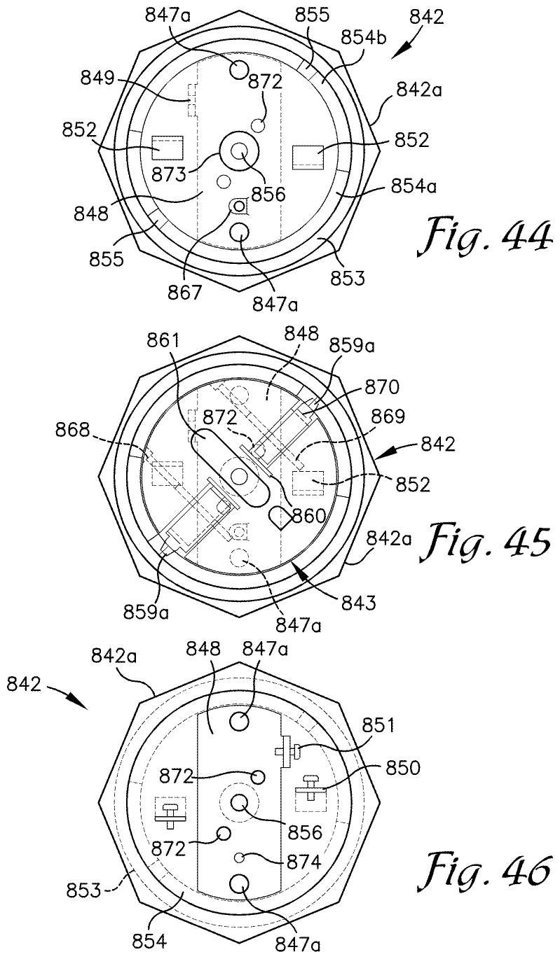

The body assembly 842 includes body 842a illustrated in FIG. 46 with a base 848, two switch receivers 852 illustrated in FIGS. 42, 44-45, and the ground contact 867 fastened through the body 842a to the base 848 through passage 874. The base 848 has threaded receivers 847 illustrated in FIG. 43 for attaching the bottom cap 841, two lock receivers 872 for the twist locks 871 to pass through, and a central receiver 56 for receiving a fastener which holds the body 842a, the socket 843 and the top cap 844 together with the base 848. The base 848 also includes a tab 849 illustrated in FIG. 44 for a ground connection. The switch receivers 852 have extensions 850 that pass through slotted openings in the body 842a which are in electrical communication with the power supply (not shown) and which provide live and neutral power to the socket 843.

The body 842a has a ridge 853 which supports the top cap 844, and a lower ridge 854 which provides a first and second support 854a and 854b which controls power for the plug blade locks 858. The body 842a also has a passage 873 which allows the bottom of the sockets 843 to rest on base 848.

The socket assembly 843 is shown in FIGS. 37 and 41 with two slots 857 whose width is determined by the width of the received plug tines (not shown). Each of these slots 857 terminates at blade contact 860, which includes an “L” shaped contact end 857 with receiver 852 for selective energizing the received plug (not shown).

Knockouts 862 are positioned at a distal end of each blade contact 860 which allow both twist locks 871 to engage a side of the socket slots, thus preventing rotation of the socket unless both plug blades (not shown) press both plungers 871c down below the second support 854b. The twist lock 871 also serves as a rotational stop when twisting the socket assembly 843 counter clockwise from the powered to the unpowered state.

The socket assembly slots also contain two blade locks 858 which pivot on pins 869 installed through holes 868. When the top cap 844 is installed, the tongue ends 859 of the blade locks 858 are biased downward by torsion springs 870, also around pins 869. In the unpowered state the proximate end 859a of tongue end 859 rests on the first support 854a, adjacent to the ramp 855 as shown in FIG. 45, a composite of FIG. 41 and FIG. 44.

With a standard electrical plug in the socket 843, the twist locks plungers 871c are pressed below the socket slots allowing rotation of the socket 843. As rotation begins, the blade lock tongues 859 slide down the ramp 855 under pressure from springs 871b until the opposite ends of the blade locks 858 contact the plug blades (not shown) to insure proper electrical conductivity between the blades (not shown) and the blade contacts 860. When the plug blades (not shown) are engaged by the blade lock tongues 859 the plug blades (not shown) resists removal by the blade locks 858. The second support 854b is positioned so that the blade locks 858 are engaged by the plug blades prior to the tongue 859b engaged by the second support 854b. When the socket 843 is rotated counter clockwise, the tongue 859b is raised by the ramp 855 freeing the plug (not shown) and reinstating the twist locks 871 into the socket slots.

The socket top has an oval shaped depression 861 which mates with the projection 863 of the top cap 844 to for alignment during rotation. The socket 843 also has a passage 867a for passage of the ground tine to ground contact 867, and a central receiver 856 for receiving a mechanical fastener and securing the top cap 844, socket 843, and the body 842 to the base 848. The top cap 844 and the socket pivot are secured at the central receiver 856. The lower end of the socket 843 goes through passage 873 and rests on base 848.

The top cap 844 shown in FIGS. 39 and 40 has the standard openings 864 and 867 for receiving a standard plug blade (not shown), a central receiver 856 and countersink 865, and a projection 863 for mating with depression 861 in the socket 843.

FIG. 38 is a composite of FIGS. 35, 36, 37, and 39 showing how everything fits together. The composite receptacle is in the powered position. FIG. 45 is a top view of the body 842 and socket 843 in the unpowered position.

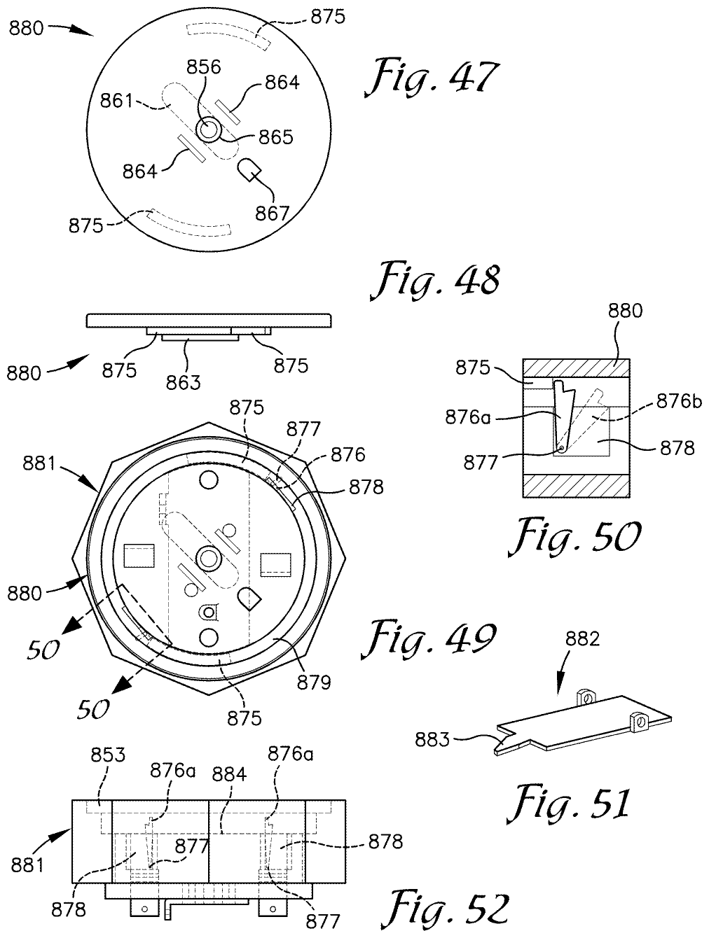

FIGS. 47-52 illustrates an alternative plug lock 882 with an alternative tongue 883 which assists in removal of the plug 802 in the unpowered condition. The present alternative embodiment utilizes an alternative base assembly 881, the alternative tongue 883, and an additional ridge structure 875 in the alternative top cap 880. This variation includes lifters 876 which rotate between a powered position with the lifters 876 in a roughly vertical position 876a, the tongue 883 of the alternative plug lock 882 held by the lifters (FIG. 50), and an unpowered position with the lifters 876 in the lowered position 876b when the socket 843 is rotated to the unpowered position. Ridges 875 located on the top cap 880 maintain the lifters 876 in the lowered position 876b from the unpowered position to the powered position of the socket 843. When the socket 843 is rotated counter-clockwise towards the unpowered position, the tongue 883 may be utilized for lifting or removal of the plug (not shown).

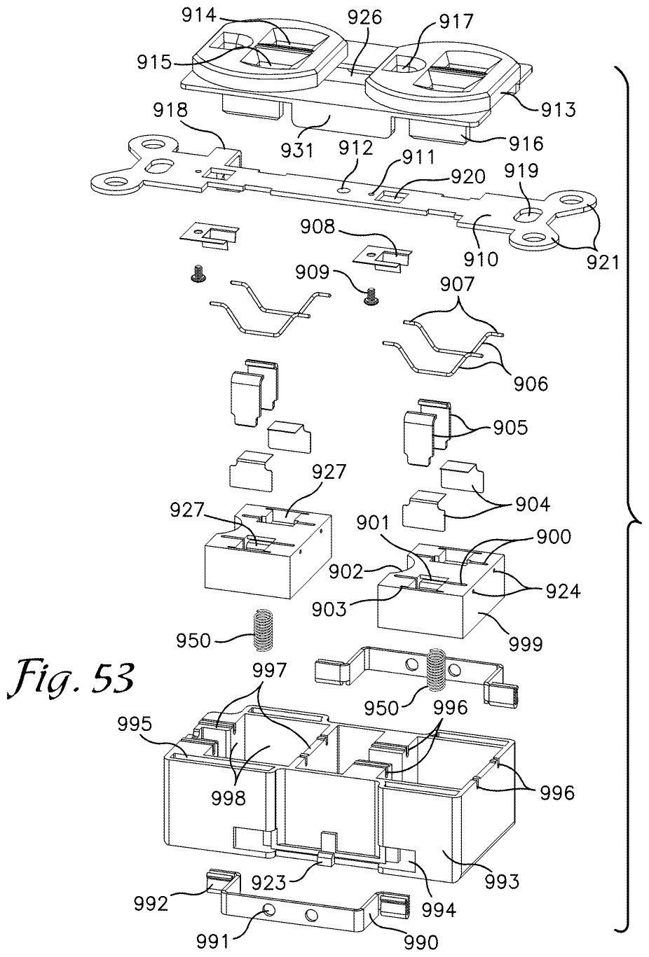

FIG. 53-60 shows another exemplary implementation of the present invention, a linear activated tamper resistant power receptacle 899 in which the power switching movement is linear. This implementation is most appropriate for general purpose receptacles as it does not limit the plug (not shown) from removal during use, but incorporates many of the previously discussed features which are harder to defeat than the prior discussed embodiments.

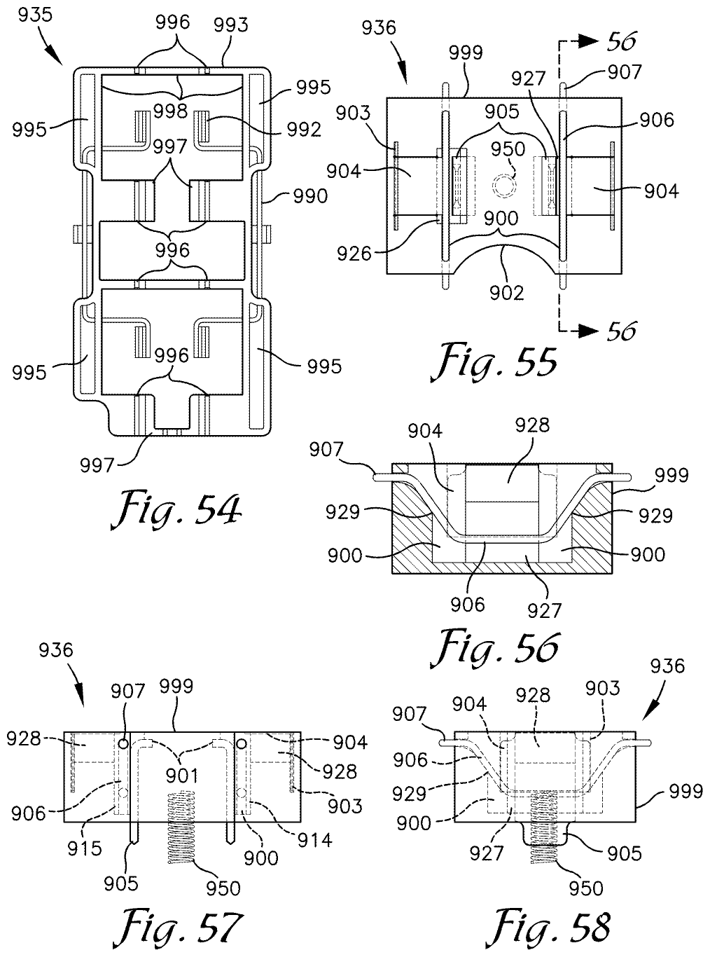

In operation, the plug (not shown) is plugged in to the linear socket with a pushing motion and removed in the customary fashion. The linear socket embodiment includes many of the previously described components in connection with the earlier embodiments, including the body assembly 935 shown in FIG. 53-54, an embodiment of a sliding socket assembly 936 shown in FIG. 55-58, the top cap 913 adapted for fastening to a mounting frame 910 shown in FIG. 53. FIG. 53 is an exploded view of the receptacle showing many of the components.

The mounting frame 910 includes two ground contacts 908 mechanically fastened to the mounting frame 910. Although screw fasteners are illustrated throughout the application, the inventions disclosed herein may utilize any means of fastening that provides sufficient electrical communication between the power supply (not shown) and the contacts 908, 905 and 906. The mounting frame 910 has the usual mounting holes 919 and plaster ears 921, holes 920 for the ground contacts 908, a threaded hole 912 for attaching a cover plate (not shown), and a downwardly depending tab 918 with threaded hole for grounding.

The body assembly 935 illustrated in FIG. 54 includes the body 993 a live and neutral power bus 990 as shown in FIG. 54. The body 993, has sufficient size and shape for receiving commonly used receptacles and provides openings 994 and clips 923 for the power busses 990 which include interior located switch receivers 992 located at each end of each power bus 990 along with threaded holes 991 (FIG. 53) for properly mounting power cables (not shown).

Internally the body 993 has two inner recesses 998 generally defined by a sidewall associated with the body 993 which are adapted for slideable receipt of the sliding socket assemblies 936. A pair of body slots 996 are located in association with each inner recess 998 on the body 993, in which resilient member ends 907 of the socket assemblies 936 are received for spacing the socket assembly 936 vertically from the switch receivers 992. The resilient member ends 907 are configured to limit electrical connectivity with the switch receivers 992. In one embodiment, the resilient member ends 907 limit electrical engagement of the sliding socket with the switch receivers 992 until a properly dimensioned plug (not shown) with plug blades (not shown) is passed through the top cap 913. The body recess 997 allows for reciprocal movement of the received sliding socket assembly 936 during operation from the unpowered to the powered state.

The linear socket assembly 936 is shown in greater detail in FIGS. 55-58, includes a generally rectangular shaped block with an optional arcuate passage 902 for passage of a ground tine associated with a three-prong plug. Additional socket assembly 936 components include plug tabs 905, a blade slot 903 adapted for receipt of a blade lock 904, and a pair of pocket slots 900 adapted for receipt of a slide lock spring 906 having resilient member end 907. Plug tabs 905 include a curved region which are adapted for receipt by upper slots 901 in the linear sliding block 999, being spaced apart appropriately for electrical contact with two plug blades (not shown), the plug tabs 905 lying between the plug blades (not shown). The plug tabs 905 protrude through bottom slots located on the bottom of the sliding block 999 and form an electrical contact switch between the receivers 992 on the power busses 990 in the body assembly 935. Each socket block has slots 127 sized appropriately for the width of the blade it must accommodate when a polarized plug is inserted. The slots 127 in the socket block 99 are the continuation of the slots 114 and 115 in the top cap (FIG. 53, 59-60) sized for the hot and neutral blades respectively.

The internal structure of the sliding block 999 is most easily illustrated in FIG. 56 which is a section view along a line 56-56 of FIG. 55, looking in the direction of the arrows. Before the insertion of a plug (not shown), the linear socket assembly 936 is suspended above the rectangular recess 998 of the body 993 by the slide resilient member ends 907 in the four body slots 996 with the plug tabs 905 spaced from but positioned for receipt by the switch receivers 992.

In an operational embodiment of the linear socket assembly 936 depicted in FIG. 56, the space between the blade lock 904 and the plug tab 905 is narrower than the thickness of the plug's blades, therefore, when a plug (not shown) is inserted into the socket assembly 936 it engages the blade locks 904. The blade locks 904 are then pushed down into cavity 928, enlarging the width of the upper slots 901 for passage of the plug blades (not shown) through the upper slots 901 to the slide lock springs 906. The slide lock springs 906 are located within the pocket slots 100 which are generally parallel to the wide direction of the blade slots 927. As the plug (not shown) is pushed further into the receptacle 899, two protrusions 129 in each spring slot 900 spaced apart on each side of the pocket deflect the resilient member 906 causing the resilient member ends 907 to inwardly retract within the socket assembly 936, allowing the plug blades (not shown) to electrically communicate with the plug tabs 905 engaging the switch receivers 992 on the power tabs 990 in the body assembly 935. In this orientation, the plug (not shown) is in the powered position.

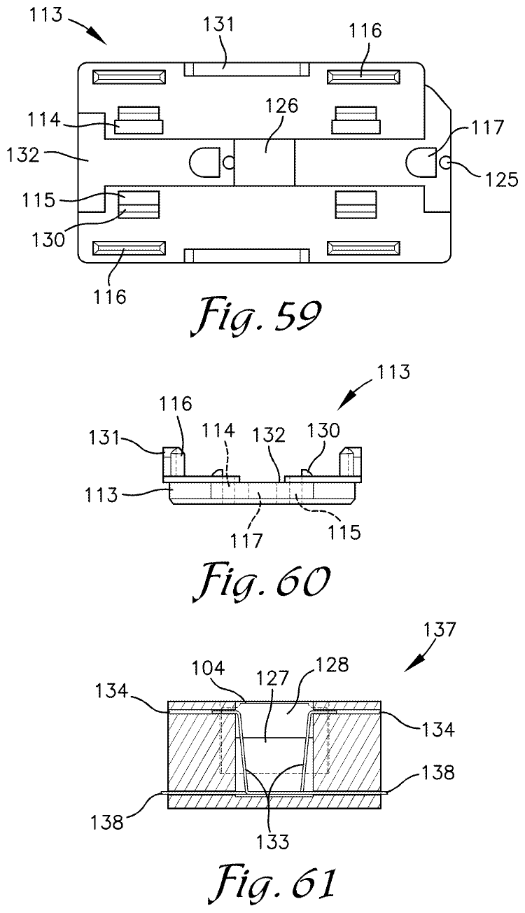

When the plug is removed from the linear socket assembly 899, the blade locks 104 engage the plug blades (not shown), allowing the socket assembly 935 to moves upwards until the blade locks 104 engage the blade freeing projections 930 in the top cap 913 as further illustrated in FIGS. 59-60. Upon engagement with the blade freeing projections 930, the blade locks 904 into the cavity 928 allowing the plug blade (not shown) to be removed from the socket assembly 936. When this happens the linear resilient members 906 return to a non-deflected state with the resilient member ends 907 protrude through the sliding lock 936 into body slots 996 associated with the linear body 993 supporting the linear sliding lock 936 in the unpowered state. The improved linear socket assembly 899 provides an improvement with four linear resilient ends 907 limiting undesired movement of the sliding socket 936 from the unpowered to the powered state.

The resilient member 906 in FIG. 56 helps to prevent received foreign objects from accidental power. If a foreign object (not shown) presses the resilient member 906 near either bottom bend, only one of the resilient member ends 907 will be retracted from the sliding lock 936. Typical plug blades (not shown), having a flat bottom and will press evenly on the both sides of the resilient member 906 thus unlocking the sliding lock 936.

The top cap 913 of the linear receptacle is shown in FIG. 53. An alternative top cap is also illustrated in FIGS. 59-60. The alternative top cap 913a includes the usual blade inlets for receiving a plug with a live blade 914, neutral blade 915 and ground tine 917. The alternative top cap 913a also includes an opening for a standard cover plate to be mechanically secured to the mounting frame 910. The alternative top cap 913a may be adhesively secured to the base 993 with projections 916 received by the four base slots 995 and the two side flaps 931 which are positioned near the outer contour of base 993. The underside of the alternative top cap 913a includes a recess 932 in which the mounting frame 910 fits, with the four blade freeing projections 930 (one adjacent to each power blade slot), and two ground contacts 908 for optionally affixing the ground contacts 908 to the mounting frame 910.

FIG. 61 shows an alternative embodiment of the linear sliding lock 937a in a sectional view similar to FIG. 55 in which an embodiment of the linear sliding socket 936 was illustrated. This alternative linear sliding socket assembly 936a is very similar to socket 936 except for the alternative linear sliding lock 937a. Instead of a separate sliding lock spring slot 900 as illustrated in the linear socket 936, the alternative linear sliding lock 937a includes plural alternative blade slots 927 which are wider than the width of the received plug blade (not shown) since the it shares the alternative blade slots 927 with plural alternative linear resilient members 933. The alternative linear resilient members 933 frictionally engage passages 934, then traverse the pocket in a downward slope towards the bottom of the alternative blade slot 927, and traversing the bottom of the alternative blade slot 927, the alternative linear resilient member ends 938 extending through resilient end passages at the bottom of the slot 927. The alternative linear resilient member ends 938 of the alternative linear resilient members 933 rest on receivers (not shown) in the socket guiding walls 998 of an alternative body assembly (not shown) which is identical to that of 935 in FIG. 54 except for the afore mentioned receivers instead of slots 996. These receivers (not shown), from which the alternative linear sliding lock 937a extends vertically above the switch receivers 92, would be somewhat larger in diameter than the alternative linear resilient members 933 to allow the alternative linear sliding socket 936a engage the blade lock release tabs 930 when the plug (not shown) is removed from the socket 936a. When a plug (not shown) is inserted into the alternative linear socket 936a, the plug blades (not shown) engage the blade lock 904, pushing it into the cavity 928, the plug blades passing therethrough. The width of each blade (not shown) compresses the blade lock springs 933 toward the side walls of the blade slots 927, retracting the ends 938 into the socket assembly 937. This allows the socket assembly 937 to slide downward, putting the plug tabs 905 into the switch receivers 992 in the powered state for electrical communication with the plug (not shown).

Generally, the advantage of this embodiment of the linear sliding locking system is its simplicity. The power slot generally has to accommodate plug blades of different widths depending on whether a polarized plug was inserted or a 3-prong plug. The shape of the resilient members 933 would have to accommodate the narrower power blade of a three prong plug, which means that a wider polarized plug blade may unlock the slide lock on its side of the socket before the neutral blade. The previously detailed embodiment of the linear sliding lock system with resilient member 906 may allow the slide locks to pass simultaneously through the sliding lock without regard to which type of plug is received.

The embodiments detailed here are not meant to be exclusive. Other embodiments in which other linear movements or rotation counter clockwise could be used to operate a switch. Different types of switches could be used, and since the neutral terminal ordinarily is not dangerous, only the hot side of the power bus might be switched. Other blade locks which use the holes in plug blades have been described, and jamming locks without the downward depending lip which help align the locking spring with the plug slots previously described may be used.

It is to be understood that while certain forms of the present invention have been illustrated and described herein with reference to the accompanying drawings, it is to be understood that various changes and modifications will become apparent to those skilled in the art. Such changes and modifications are to be understood as being included within the scope of embodiments of this invention as defined by the appending claims.

1-9. (canceled)

10. A safety receptacle, comprising:
a support body having power buses accessible to power and a socket cavity;
a socket provided within the socket cavity movable between a first position and a second position;
an electrically conductive plug blade receiver provided within the socket and configured to connect physically and electrically with a power bus when the socket is in the second position, and is spatially separated and electrically decoupled from the power bus when the socket is in the first position;
an electrical conduction barrier configured to block foreign objects from accessing power when the socket is in the first position;
a movement lock having a plurality of locking elements configured to be in the locked position to fix the socket in the first position, but responsive to insertion of a standard plug, the plurality of locking elements are moved to an unlocked position, allowing the socket to move to the second position connecting the plug to power;
a plug lock configured to lock plug blades in the socket in the second position until the socket is returned to the first position; and
a top cap with openings sized to allow standard plug blades to pass through.

11. A safety receptacle, comprising:
a top cap having a plurality of openings configured to admit a plurality of standard plugs;
a case having a plurality of power buses configured to be connectable to power;
a socket provided under the top cap and configured with a barrier to prevent foreign objects from accessing power, the power blade slots of the socket communicating with the top cap openings, the socket movable between a first position and a second position;
a plug blade receptor provided within each of the power blade slots, each of the plug blade receptors configured to connect physically and electrically with a respective one of the power buses when the socket is in the second position;
a movement lock configured to fix the socket in the first position until the plug blades are inserted, thereby unlocking the movement lock and allowing the socket to move to the second position and connect the plug to power; and
a plug lock configured to lock the plug into the socket when the socket leaves the first position until the socket is returned to the first position.

12. A movement lock, comprising:
a body having a shaped cavity;
at least one locking element within the shaped cavity with the at least one end of the locking element lying against a stop outside of the body preventing movement; and
a key configured to fit the body cavity and bend the at least one locking element when received in the cavity in a manner that retracts the at least one locking element end into the body allowing movement.
